(19) United States
(12) Patent Application Publication
(10) Pub. No.: US 2026/0302618 A1
(43) Pub. Date: Oct. 1, 2026

(54) LIQUID CRYSTAL ARRAY ANTENNA STRUCTURE

(71) Applicant: TMY Technology Inc., New Taipei City (TW)

(72) Inventors: Hsi-Hsir Chou, New Taipei City (TW); Yun-Hao Chang, New Taipei City (TW)

(73) Assignee: TMY Technology Inc., New Taipei City (TW)

(21) Appl. No.: 19/346,500

(22) Filed: Sep. 30, 2025

(30) Foreign Application Priority Data
Mar. 31, 2025 (TW) 114112385

(51) Int. Cl. H01Q 5/20; H01Q 21/06

(52) U.S. Cl. CPC H01Q 5/20; H01Q 21/065

(57) ABSTRACT

A liquid crystal array antenna structure is provided in the disclosure. The liquid crystal array antenna structure includes a first substrate layer, a second substrate layer, a third substrate layer, four liquid crystal units, a first surface unit, a second surface unit, a third surface unit, and a fourth surface unit. The four liquid crystal units are arranged between the first substrate layer and the second substrate layer. When a bias voltage is applied to the liquid crystal units, a central operating frequency and a beam scanning range of the liquid crystal array antenna structure are a first frequency band and a first range, respectively.

### CROSS-REFERENCE TO RELATED APPLICATION

This application claims the priority benefit of Taiwan application serial no. 114112385 filed on Mar. 31, 2025. The entirety of the above-mentioned patent application is hereby incorporated by reference herein and made a part of this specification.

### BACKGROUND

### Technical Field

The disclosure relates to an antenna array structure, and in particular relates to a liquid crystal array antenna structure.

### Description of Related Art

A liquid crystal array antenna structure is an antenna system constructed using liquid crystal materials, and its performance is related to the arrangement of liquid crystal molecules. Specifically, the key characteristics of the liquid crystal array antenna structure lie in its adjustability and flexibility. By adjusting the arrangement of liquid crystal molecules (i.e., applying voltage to the liquid crystal unit), beam steering and beam forming may be achieved, enabling the liquid crystal array antenna structure to respond to different communication requirements.

### SUMMARY

In view of this, a liquid crystal array antenna structure capable of performing beam scanning by applying different voltages to liquid crystal units is provided in the disclosure.

A liquid crystal array antenna structure is provided in an embodiment of the disclosure. The liquid crystal array antenna structure includes a first substrate layer, a second substrate layer, a third substrate layer, four liquid crystal units, a first surface unit, a second surface unit, a third surface unit, and a fourth surface unit. The first substrate layer has a first upper surface and a first lower surface. The second substrate layer has a second upper surface and a second lower surface. The third substrate layer has a third upper surface and a third lower surface. The four liquid crystal units are arranged between the first substrate layer and the second substrate layer. The first surface unit is arranged at the first lower surface. The second surface unit is arranged at the second upper surface. The third surface unit is arranged at the third upper surface. The fourth surface unit is arranged at the third lower surface. When a bias voltage is applied to the liquid crystal units, a central operating frequency and a beam scanning range of the liquid crystal array antenna structure are a first frequency band and a first range, respectively.

In an embodiment of the disclosure, the first surface unit includes four first surface internally wound bias metal wires. The four first surface internally wound bias metal wires respectively correspond to the four liquid crystal units.

In an embodiment of the disclosure, each of the first surface internally wound bias metal wires is connected to an edge of the first lower surface. The four second surface region patch groups respectively correspond to the four liquid crystal units.

In an embodiment of the disclosure, each of the first surface internally wound bias metal wires is an equidistant square spiral metal wire.

In an embodiment of the disclosure, the number of turns of the equidistant square spiral metal wire is at least 2.

In an embodiment of the disclosure, the second surface unit includes four second surface region patch groups.

In an embodiment of the disclosure, the four second surface region patch groups are arranged in a binomial array.

In an embodiment of the disclosure, each of the second surface region patch groups includes three surface cross-shaped patches, and central points of the three surface cross-shaped patches are connected to each other through surface inner metal wires.

In an embodiment of the disclosure, one of the three surface cross-shaped patches is connected to an edge of the second upper surface through a surface outer metal wire.

In an embodiment of the disclosure, each of the surface cross-shaped patches includes a surface left-side patch, a surface central patch, a surface right-side patch and a surface connection patch. The surface left-side patch, the surface central patch, and the surface right-side patch are connected through the surface connection patch. A length and a width of the surface left-side patch are the same as a length and a width of the surface right-side patch. A length of the surface central patch is greater than the length of the surface left-side patch and the length of the surface right-side patch. The width of the surface left-side patch, the width of the surface central patch, and the width of the surface right-side patch are the same.

In an embodiment of the disclosure, the third surface unit is a metal ground layer.

In an embodiment of the disclosure, the third surface unit includes four surface slit groups. The four surface slit groups respectively correspond to the four liquid crystal units.

In an embodiment of the disclosure, each of the surface slit groups includes three third surface slits.

In an embodiment of the disclosure, the third surface slits are H-shaped slits.

In an embodiment of the disclosure, the fourth surface unit includes two three-stage one-to-six distribution lines.

In an embodiment of the disclosure, feeding terminals of the two three-stage one-to-six distribution lines are connected to edges of the third lower surface.

In an embodiment of the disclosure, output terminals of the two three-stage one-to-six distribution lines respectively correspond to the third surface slits of the third surface unit.

In an embodiment of the disclosure, the first surface unit, the second surface unit, the third surface unit and the fourth surface unit are all formed of a metal material.

In an embodiment of the disclosure, the first frequency band is 14 GHz to 15 GHz.

In an embodiment of the disclosure, the first range is ±23 degrees to ±25 degrees.

Based on the above, the liquid crystal array antenna structure of the disclosure, through its special structural design, may provide a central operating frequency and a beam scanning range that may meet the communication requirements of low Earth orbit satellites.

### BRIEF DESCRIPTION OF THE DRAWINGS

FIG. 1A is a schematic diagram showing a multi-layer structure of a liquid crystal array antenna structure of an embodiment of the disclosure.

FIG. 1B is a cross-sectional diagram showing a liquid crystal array antenna structure of an embodiment of the disclosure.

FIG. 2A is a schematic diagram showing a unit cell design of a first surface unit of an embodiment of the disclosure.

FIG. 2B is a schematic diagram showing a unit cell design of a liquid crystal unit of an embodiment of the disclosure.

FIG. 2C is a schematic diagram showing a unit cell design of a second surface unit of an embodiment of the disclosure.

FIG. 2D is a schematic diagram showing a surface cross-shaped patch in a second surface unit of an embodiment of the disclosure.

FIG. 2E is a schematic diagram showing a unit cell design of a third surface unit of an embodiment of the disclosure.

FIG. 2F is a schematic diagram showing a third surface slit in a third surface unit of an embodiment of the disclosure.

FIG. 2G is a schematic diagram showing a unit cell design of a fourth surface unit of an embodiment of the disclosure.

FIG. 2H is a schematic diagram showing a three-stage one-to-six distribution line in a fourth surface unit of an embodiment of the disclosure.

FIG. 3A is a schematic diagram showing the S11 parameter of the liquid crystal array antenna structure of the first embodiment of the disclosure.

FIG. 3B shows a beam scanning gain diagram of the liquid crystal array antenna structure of the first embodiment of the disclosure.

FIG. 4A is a schematic diagram showing the S11 parameter of the liquid crystal array antenna structure of the second embodiment of the disclosure.

FIG. 4B shows a beam scanning gain diagram of the liquid crystal array antenna structure of the second embodiment of the disclosure.

FIG. 5A is a schematic diagram showing the S11 parameter of the liquid crystal array antenna structure of the third embodiment of the disclosure.

FIG. 5B shows a beam scanning gain diagram of the liquid crystal array antenna structure of the third embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

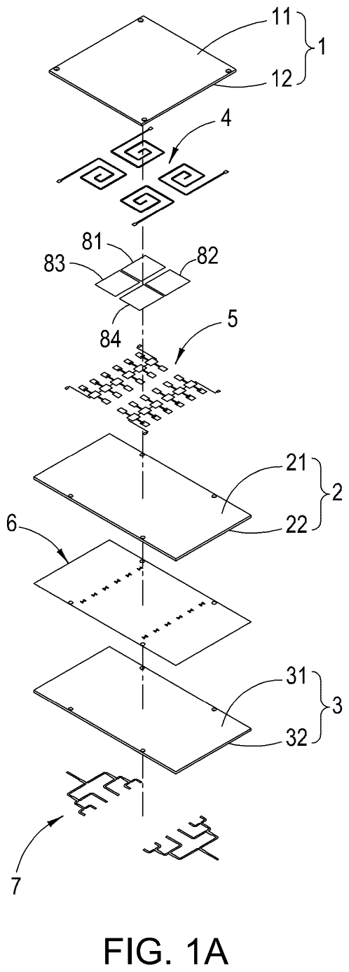

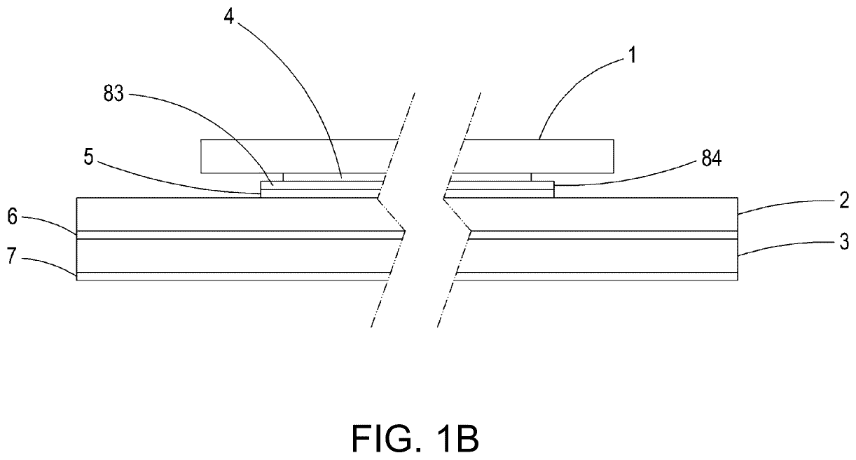

FIG. 1A is a schematic diagram showing a multi-layer structure of a liquid crystal array antenna structure of an embodiment of the disclosure. FIG. 1B is a cross-sectional diagram showing a liquid crystal array antenna structure of an embodiment of the disclosure. Referring to FIG. 1A and FIG. 1B, the design of the liquid crystal array antenna structure is mainly a three-layer four-sided circuit board, and the liquid crystal array antenna structure includes a first substrate layer 1, a second substrate layer 2, a third substrate layer 3, a first surface unit 4, a second surface unit 5, a third surface unit 6, a fourth surface unit 7, and at least four liquid crystal units 81, 82, 83, and 84. The first substrate layer 1 has a first upper surface 11 and a first lower surface 12. The second substrate layer 2 has a second upper surface 21 and a second lower surface 22. The third substrate layer 3 has a third upper surface 31 and a third lower surface 32.

The liquid crystal units 81, 82, 83, and 84 are arranged between the first substrate layer 1 and the second substrate layer 2. The first surface unit 4 is arranged at the first lower surface 12. The second surface unit 5 is arranged at the second upper surface 21. The third surface unit 6 is arranged at the third upper surface 31. The fourth surface unit 7 is arranged at the third lower surface 32.

The first substrate layer 1, the second substrate layer 2 and the third substrate layer 3 may be, for example, high-frequency printed circuit boards. The material used for the first substrate layer 1, the second substrate layer 2 and the third substrate layer 3 may be, for example, Rogers RO4533. In one embodiment, the dielectric constant of the first substrate layer 1, the second substrate layer 2 and the third substrate layer 3 may be, for example, 3.0 to 4.0 (the optimal dielectric constant is 3.45), the tangent loss (dissipation factor) may be, for example, 0.002 to 0.003 (the optimal tangent loss is 0.0025), and the thickness may be, for example, 0.50 to 0.51 mm (the optimal thickness is 0.508 mm).

The first surface unit 4, the second surface unit 5, the third surface unit 6 and the fourth surface unit 7 may be formed of, for example, a metal material (e.g., a metal conductor such as copper foil, gold foil, or other metal oxide conductor such as indium tin oxide). The thickness of the copper foil of the first surface unit 4, the second surface unit 5, the third surface unit 6 and the fourth surface unit 7 may be, for example, 0.035 mm. The third surface unit 6 is a metal ground layer.

The liquid crystal material used in the liquid crystal units 81 to 84 may be, for example, JNC ZOC-A 018XX, MERCK E7 or MERCK GT7-29001, and the thickness thereof is 0.1 mm. The liquid crystal units 81 to 84 have adjustable dielectric characteristics. When an external voltage is applied to the liquid crystal units 81 to 84, the rotation of the liquid crystal molecules may be changed, thereby changing the dielectric constant and the tangent loss.

Taking JNC ZOC-A018XX as an example, the dielectric constant and tangent loss of liquid crystal units 81 to 84 are 2.55 to 3.76 and 0.004 to 0.007 respectively. When no bias voltage is applied to the liquid crystal units 81 to 84, the liquid crystal alignment directions of the liquid crystal units 81 to 84 are parallel to the electric field direction, and the dielectric constants of the liquid crystal units 81 to 84 are 3.76 and the tangent loss is 0.004. On the other hand, when a bias voltage is applied to the liquid crystal units 81 to 84, the liquid crystal alignment directions of the liquid crystal units 81 to 84 are perpendicular to the electric field, the dielectric constant becomes 2.55, and the tangent loss becomes 0.007.

Taking MERCK E7 as an example, the dielectric constant and tangent loss of liquid crystal units 81 to 84 are 2.72 to 3.17 and 0.033 to 0.05 respectively. When no bias voltage is applied to the liquid crystal units 81 to 84, the liquid crystal alignment directions of the liquid crystal units 81 to 84 are parallel to the electric field direction, and the dielectric constants of the liquid crystal units 81 to 84 are 3.17 and the tangent loss is 0.033. On the other hand, when a bias voltage is applied to the liquid crystal units 81 to 84, the liquid crystal alignment directions of the liquid crystal units 81 to 84 are perpendicular to the electric field, the dielectric constant becomes 2.72, and the tangent loss becomes 0.05.

Taking MERCK GT7-29001 as an example, the dielectric constant and tangent loss of liquid crystal units 81 to 84 are 2.46 to 3.53 and 0.0064 to 0.0116 respectively. When no bias voltage is applied to the liquid crystal units 81 to 84, the liquid crystal alignment directions of the liquid crystal units 81 to 84 are parallel to the electric field direction, and the dielectric constants of the liquid crystal units 81 to 84 are 3.53 and the tangent loss is 0.0064. On the other hand, when a bias voltage is applied to the liquid crystal units 81 to 84, the liquid crystal alignment directions of the liquid crystal units 81 to 84 are perpendicular to the electric field, the dielectric constant becomes 2.46, and the tangent loss becomes 0.0116.

The dielectric properties of the liquid crystal units 81 to 84 change with the electric field, thereby changing the beam characteristics of the liquid crystal array antenna structure. To further illustrate, when no bias voltage is applied to the liquid crystal units 81 to 84, the arrangement direction of the liquid crystal molecules in the liquid crystal units 81 to 84 is parallel to the metal patch and the metal ground plane. In addition, when a bias voltage is applied to the liquid crystal units 81 to 84, the arrangement direction of the liquid crystal molecules is perpendicular to the metal patch and the metal ground plane, thereby achieving an offset effect of the central operating frequency of the liquid crystal array antenna structure.

The types of the first substrate layer 1, the second substrate layer 2, the third substrate layer 3 and the liquid crystal units 81 to 84 may be designed according to actual requirements, and the disclosure is not limited thereto.

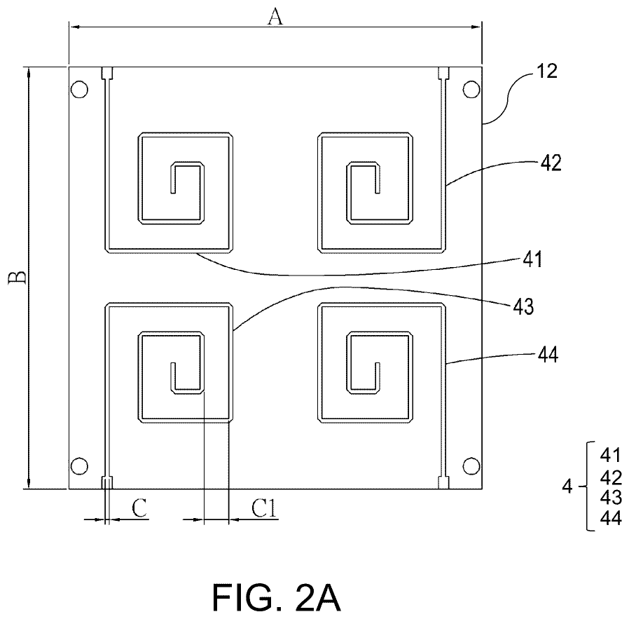

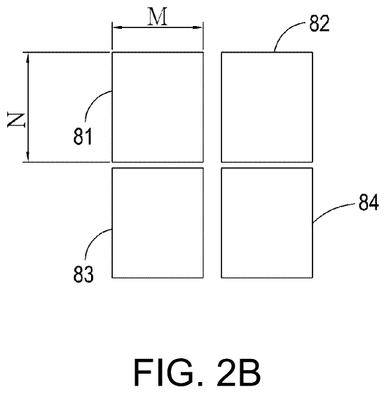

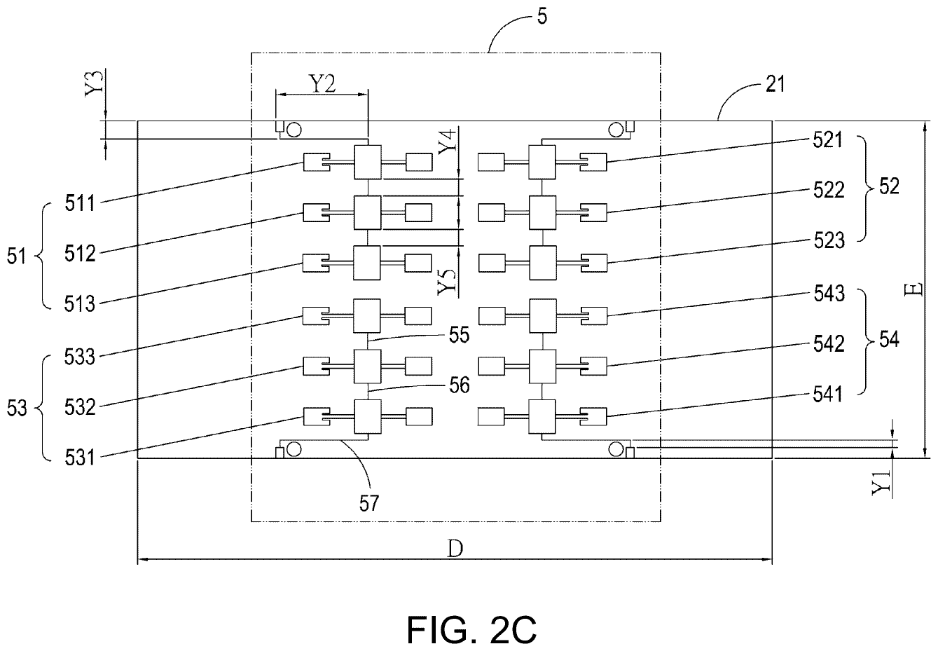

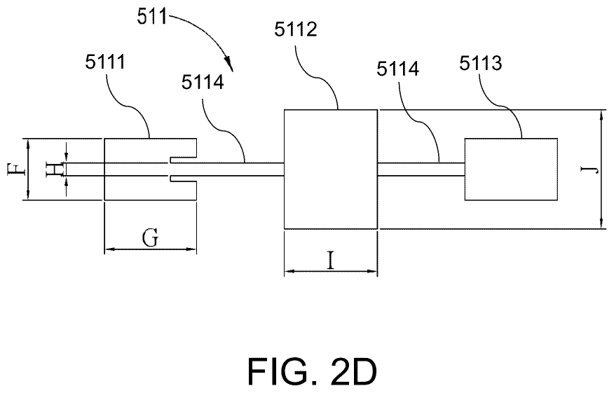

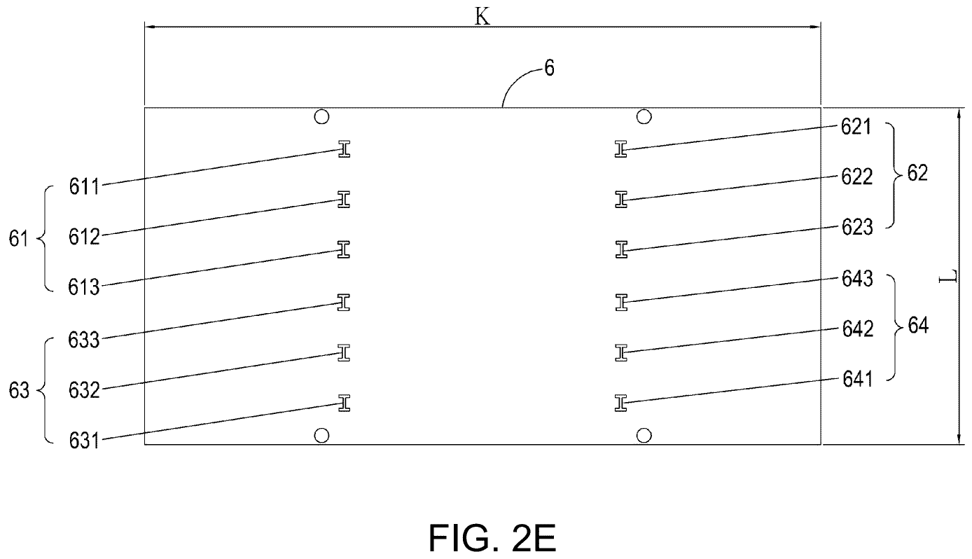

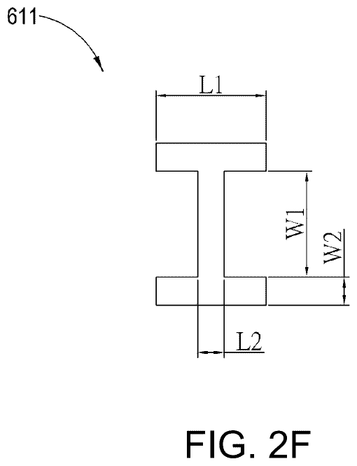

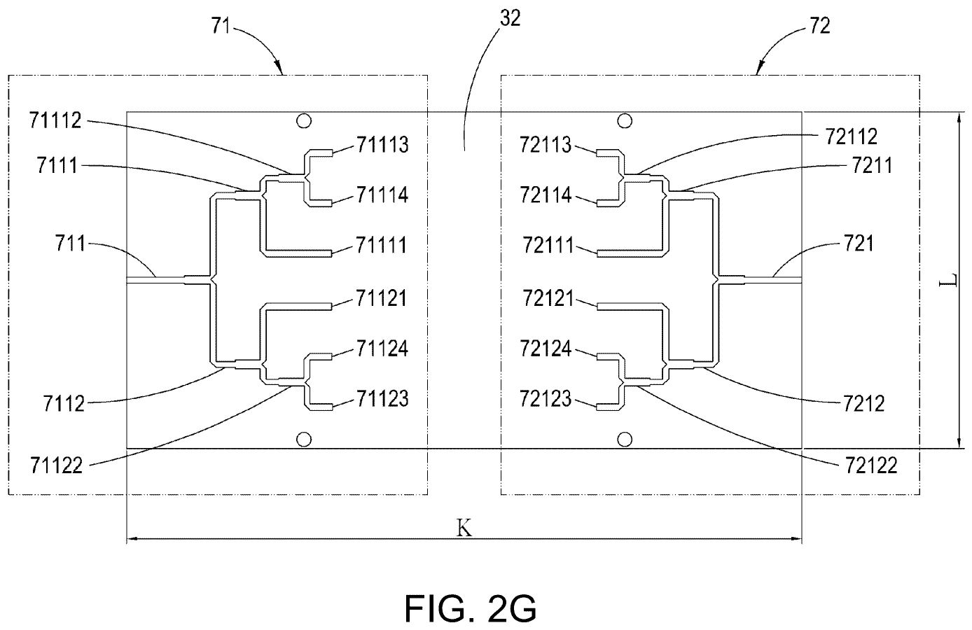

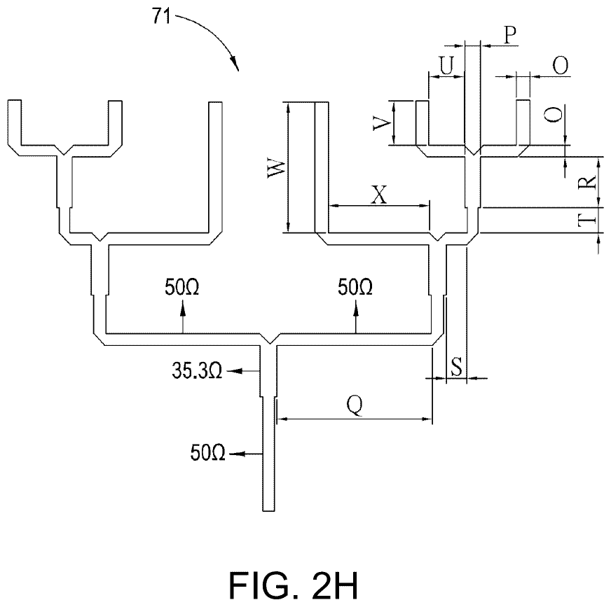

FIG. 2A is a schematic diagram showing a unit cell design of a first surface unit of an embodiment of the disclosure. FIG. 2B is a schematic diagram showing a unit cell design of a liquid crystal unit of an embodiment of the disclosure. Referring to FIG. 2A and FIG. 2B, the first surface unit 4 is located at the first lower surface 12. The original metal layer (e.g., copper foil with a thickness of 0.035 mm) of the first lower surface 12 is etched to form the first surface unit 4.

The first surface unit 4 includes four first surface internally wound bias metal wires 41 to 44. The first surface internally wound bias metal wires 41 to 44 are equidistant square spiral metal wires. The first surface internally wound bias metal wires 41 to 44 respectively correspond to the liquid crystal units 81 to 84. In addition, the first surface internally wound bias metal wires 41 to 44 are connected to the edges of the first lower surface 12.

It should be noted that the bias voltage wires in a loop (spiral) shape formed by the first surface internally wound bias metal wires 41 to 44 may guide the electric field to be distributed along a specific path to change the electric field distribution and refractive index distribution of the liquid crystal units 81 to 84. To further illustrate, the electric field of a specific path may, for example, cause a non-uniform refractive index distribution to affect the phase delay, thereby changing the beam and scanning direction of the liquid crystal array antenna structure. The number of turns of the first surface internally wound bias metal wires 41 to 44 is at least 2, that is, the number of loops (spirals) formed by the first surface internally wound bias metal wires 41 to 44 is at least 2.

The width and length of the first lower surface 12 are respectively marked as A and B in FIG. 2A. The width of the first surface internally wound bias metal wires 41 to 44 is marked as C in FIG. 2A. The spacing of the loops (spirals) of the first surface internally wound bias metal wires 41 to 44 is marked as C1 in FIG. 2A. The width and length of the liquid crystal units 81 to 84 are respectively marked as M and N in FIG. 2B.

In one embodiment, the width and length of the first lower surface 12 (marked as A and B in FIG. 2A) may be, for example, 67 to 68 mm (the optimal width is 67.6 mm) and 70 to 71 mm (the optimal length is 70.1 mm), respectively. The width of the first surface internally wound bias metal wires 41 to 44 (marked as C in FIG. 2A) may be, for example, less than 1 mm (the optimal width is 0.9 mm). The spacing of the loops (spirals) of the first surface internally wound bias metal wires 41 to 44 (marked as C1 in FIG. 2A) may be, for example, 4 to 5 mm (the optimal spacing to the loops is 4.55 mm). The width and length of the liquid crystal units 81 to 84 (marked as M and N in FIG. 2B) may be, for example, 28 to 29 mm (the optimal width and length are 28.6 mm).

FIG. 2C is a schematic diagram showing a unit cell design of a second surface unit of an embodiment of the disclosure. FIG. 2D is a schematic diagram showing a surface cross-shaped patch in a second surface unit of an embodiment of the disclosure. Referring to FIG. 2C and FIG. 2D, the second surface unit 5 is located at the second upper surface 21. The original metal layer (e.g., copper foil with a thickness of 0.035 mm) of the second upper surface 21 is etched to form the second surface unit 5.

The second surface unit 5 includes four second surface region patch groups 51 to 54. The second surface region patch groups 51 to 54 respectively correspond to the liquid crystal units 81 to 84. The second surface region patch groups 51 to 54 respectively include three surface cross-shaped patches 511 to 513, 521 to 523, 531 to 533, and 541 to 543. Specifically, the central points of the three surface cross-shaped patches are connected to each other through surface inner metal wires, and one of the surface cross-shaped patches is connected to the edge of the second upper surface 21 through a surface outer metal wire. Taking the second surface region patch group 53 as an example, the three surface cross-shaped patches 531 to 533 included in the second surface region patch group 53 are connected through the surface inner metal wires 55 and 56, and the surface cross-shaped patch 531 is connected to the edge of the second upper surface 21 through the surface outer metal wire 57. With regard to the second surface region patch groups 51, 52, 54, the descriptions previously provided concerning the second surface region patch group 53 shall be applicable by extension, and thus are not repeated herein.

The width and length of the second lower surface 21 are respectively marked as D and E in FIG. 2C.

In addition, regarding the specifications of the second surface unit 5, the specifications of the surface cross-shaped patches 511 to 513, 521 to 523, 531 to 533, and 541 to 543 are all the same. Taking the surface cross-shaped patch 511 as an example, the surface cross-shaped patch 511 is formed of a surface left-side patch 5111, a surface central patch 5112, a surface right-side patch 5113, and a surface connection patch 5114. The surface left-side patch 5111, the surface central patch 5112, and the surface right-side patch 5113 are connected through the surface connection patch 5114. A length (F as shown in FIG. 2D) and a width (G as shown in FIG. 2D) of the surface left-side patch 5111 are the same as a length and a width of the surface right-side patch 5113. A length of the surface central patch 5112 (J as shown in FIG. 2D) is greater than the length of the surface left-side patch 5111 and the length of the surface right-side patch 5113. The width of the surface left-side patch 5111, the width of the surface right-side patch 5113, and the width of the surface central patch 5112 (I as shown in FIG. 2D) are the same. A length of the surface connection patch 5114 is H as shown in FIG. 2D.

In one embodiment, the width and length (marked as D and E in FIG. 2C) of the second lower surface 21 may be, for example, 125 to 126 mm (the optimal width is 125.2 mm) and 66 to 67 mm (the optimal length is 66.1 mm), respectively.

In addition, the lengths of Y1, Y2, Y3, Y4 and Y5 marked in FIG. 2C are, for example, 1 to 2 mm (the optimal length is 1.19 mm), 17 to 18 mm (the optimal length is 17.48 mm), 1 to 2 mm (the optimal length is 1.72 mm), 3 to 4 mm (the optimal length is 3.30 mm) and 3 to 4 mm (the optimal length is 3.30 mm), respectively. The lengths of F, G, H, I and J marked in FIG. 2D are, for example, 3 to 4 mm (the optimal length is 3.35 mm), 5 to 6 mm (the optimal length is 5.19 mm), less than 1 mm (the optimal length is 0.57 mm), 5 to 6 mm (the optimal length is 5.19 mm) and 6 to 7 mm (the optimal length is 6.70 mm), respectively.

It should be noted that, as shown in FIG. 2C, the second surface unit 5 includes a group of 6*6 metal patches formed of 12 groups of 1*3 metal patches (i.e., surface cross-shaped patches 511 to 513, 521 to 523, 531 to 533, 541 to 543). That is, the second surface region patch groups 51 to 54 are arranged in a binomial array. Specifically, the binomial array is an antenna array designed based on the binomial coefficient distribution. It is formed of multiple antenna elements of a single type arranged in a specific geometric shape to reduce the side lobe level, thereby achieving a radiation field pattern with ideal side lobe suppression. To further illustrate, the side lobe is the secondary radiation part outside the main beam of the antenna, which will cause transmission interference and error. Therefore, good transmission performance may be achieved by suppressing the side lobe level.

FIG. 2E is a schematic diagram showing a unit cell design of a third surface unit of an embodiment of the disclosure. FIG. 2F is a schematic diagram showing a third surface slit in a third surface unit of an embodiment of the disclosure. Referring to FIG. 2E and FIG. 2F, the third surface unit 6 is located at the third upper surface 31. The original metal layer (e.g., copper foil with a thickness of 0.035 mm) of the third upper surface 31 is etched to form the third surface unit 6, in which the third surface unit 6 is a metal ground layer.

The third surface unit 6 includes four surface slit groups 61 to 64. The surface slit groups 61 to 64 respectively correspond to the liquid crystal units 81 to 84. The surface slit groups 61 to 64 respectively include three third surface slits 611 to 613, 621 to 623, 631 to 633, and 641 to 643. The third surface slits 611 to 613, 621 to 623, 631 to 633, and 641 to 643 are, for example, H-shaped slits.

The width and length of the third upper surface 31 are respectively marked as K and L in FIG. 2E.

In one embodiment, the width and length (marked as K and L in FIG. 2E) of the third upper surface 31 may be, for example, 133 to 134 mm (the optimal width is 133.2 mm) and 66 to 67 mm (the optimal length is 66.1 mm), respectively.

In addition, regarding the specifications of the third surface unit 6, the specifications of the third surface slits 611 to 613, 621 to 623, 631 to 633, and 641 to 643 are all the same. Taking the third surface slit 611 as an example, the lengths of L1, L2, W1, and W2 marked in FIG. 2F are, for example, 3 mm, less than 1 mm (the optimal length is 0.5 mm), 3 mm, and less than 1 mm (the optimal length is 0.5 mm), respectively. As shown in FIG. 2F, the two sides of the H-shaped slit (i.e., the third surface slit 611) are of equal length.

FIG. 2G is a schematic diagram showing a unit cell design of a fourth surface unit of an embodiment of the disclosure. FIG. 2H is a schematic diagram showing a three-stage one-to-six distribution line in a fourth surface unit of an embodiment of the disclosure. Referring to FIG. 2G and FIG. 2H, the fourth surface unit 7 is located at the third lower surface 32. The original metal layer (e.g., copper foil with a thickness of 0.035 mm) of the third lower surface 32 is etched to form the fourth surface unit 7.

The fourth surface unit 7 includes two three-stage one-to-six distribution lines 71 and 72. Specifically, the three-stage one-to-six distribution lines 71 and 72 may be, for example, a three-stage one-to-six power divider having a feeding terminal and six output terminals for dividing the fed signal into six output signals with equal or unequal energy. The feeding terminals (referring to the metal wires 711 and 721 in FIG. 2G) of the three-stage one-to-six distribution lines 71 and 72 are connected to the edges of the third lower surface 32, the output terminals of the three-stage one-to-six distribution line 71 correspond to the third surface slits 611 to 613 and 621 to 623 of the third surface unit 6, respectively, and the output terminals of the three-stage one-to-six distribution line 72 correspond to the third surface slits 631 to 633 and 641 to 643 of the third surface unit 6, respectively, to achieve a high-gain, high-efficiency double-sided slits feeding antenna structure.

It is worth mentioning that the liquid crystal array antenna structure of the disclosure adopts the three-stage one-to-six distribution lines 71 and 72, which effectively reduces the number of feeding terminals and thus reduces the hardware cost.

The bifurcation between branch 7111 and branch 7112 of the three-stage one-to-six distribution line 71, the bifurcation between branch 71111 and branch 71112, the bifurcation between branch 71113 and branch 71114, the bifurcation between branch 71121 and branch 71122, and the bifurcation between branch 71123 and branch 71124 are T-type joints, and tangent structures are adopted at the corners to improve the capacitance effect.

Similarly, the bifurcation between branch 7211 and branch 7212 of the three-stage one-to-six distribution line 72, the bifurcation between branch 72111 and branch 72112, the bifurcation between branch 72113 and branch 72114, the bifurcation between branch 72121 and branch 72122, and the bifurcation between branch 72123 and branch 72124 are T-type joints, and tangent structures are adopted at the corners to improve the capacitance effect.

The width and length of the third lower surface 32 are respectively marked as K and L in FIG. 2G.

In one embodiment, the width and length (marked as K and L in FIG. 2G) of the third lower surface 32 are equal to the width and length (marked as K and L in FIG. 2E) of the third upper surface 31. The width and length of the third lower surface 32 may be, for example, 133 to 134 mm (the optimal width is 133.2 mm) and 66 to 67 mm (the optimal length is 66.1 mm), respectively.

In addition, regarding the specifications of the fourth surface unit 7, the specifications of the three-stage one-to-six distribution lines 71 and 72 are the same. Taking the three-stage one-to-six distribution line 71 as an example, the length of O marked in FIG. 2H is 1 to 2 mm (the optimal length is 1.13 mm), the length of P is 1 to 2 mm (the optimal length is 1.32 mm), the length of Q is 15 to 16 mm (the optimal length is 15.1 mm), the length of R is 5 mm, the length of S is 2 to 3 mm (the optimal length is 2.28 mm), the length of T is 2 to 3 mm (the optimal length is 2.44 mm), the length of U is 3 to 4 mm (the optimal length is 3.68 mm), the length of V is 4 to 5 mm (the optimal length is 4.43 mm), the length of W is 13 to 14 mm (the optimal length is 13.01 mm) and the length of X is 10 to 11 mm (the optimal length is 10.09 mm).

In addition, the three-stage one-to-six distribution lines 71 and 72 have two wire diameters (referring to O and P marked in FIG. 2H), and different impedances are provided for different wire diameters. Specifically, the impedance of the distribution line corresponding to the length O is 50 ohms, and the impedance of the distribution line corresponding to the length P is 35 ohms.

It should be noted that the liquid crystal array antenna structure of the disclosure implements a double-sided slits feeding antenna structure through the third surface unit 6 and the fourth surface unit 7, and receives an external (bias) voltage through the liquid crystal voltages 81 to 84. The design of the liquid crystal array antenna structure of the disclosure allows for the independent design of the elements for receiving signals and the elements for receiving bias voltage, which may effectively prevent the generation of noise and save hardware costs (e.g., there is no need to install a three-way bias device).

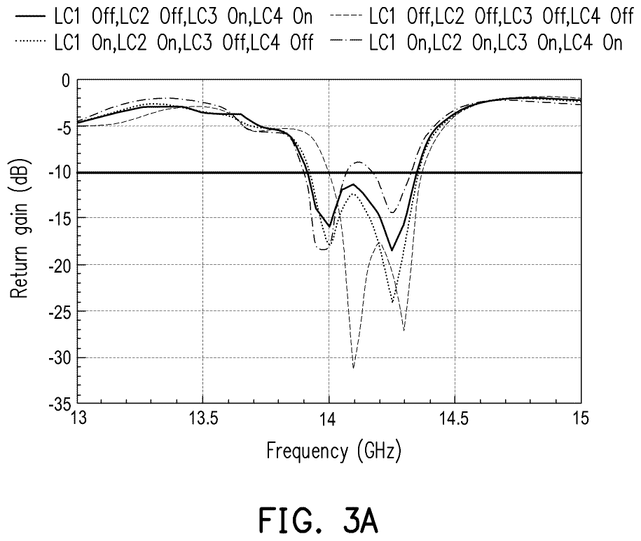

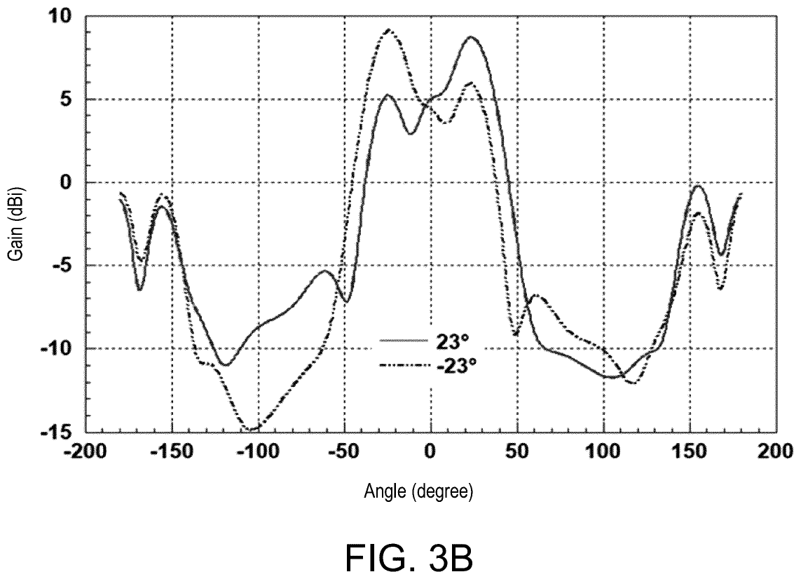

FIG. 3A is a schematic diagram showing the S11 parameter of the liquid crystal array antenna structure of the first embodiment of the disclosure. FIG. 3B shows a beam scanning gain diagram of the liquid crystal array antenna structure of the first embodiment of the disclosure. The S11 parameter is also referred to as the input reflection coefficient, which is used to indicate the return loss of the signal transmitting terminal.

Referring to FIG. 3A and FIG. 3B, in this embodiment, the liquid crystal material used in the liquid crystal units 81 to 84 is MERCK E7.

“Off” in FIG. 3A indicates that no voltage is applied to the liquid crystal units 81 to 84, “On” in FIG. 3A indicates that voltage is applied to the liquid crystal units 81 to 84, and LC1 to LC4 in FIG. 3A represent the liquid crystal units 81 to 84, respectively.

As shown in FIG. 3A, when no voltage is applied to the liquid crystal units 81 to 84, the central operating frequency of the liquid crystal array antenna structure is between 14 GHz and 15 GHz (optimally 14.10 GHz), with a bandwidth of 0.40 GHz with −10 dB as the reference point.

As shown in FIG. 3A, when voltage is applied to the liquid crystal units 81 and 82 and no voltage is applied to the liquid crystal units 83 and 84, the central operating frequency of the liquid crystal array antenna structure is between 14 GHz and 15 GHz (optimally 14 GHz), with a bandwidth of 0.35 GHz with −10 dB as the reference point.

As shown in FIG. 3A, when voltage is applied to the liquid crystal units 83 and 84 and no voltage is applied to the liquid crystal units 81 and 82, the central operating frequency of the liquid crystal array antenna structure is between 14 GHz and 15 GHz (optimally 14 GHz), with a bandwidth of 0.35 GHz with −10 dB as the reference point.

As shown in FIG. 3A, when voltage is applied to the liquid crystal units 81 to 84, the central operating frequency of the liquid crystal array antenna structure is between 13 GHz and 15 GHz (optimally 13.95 GHz), with a bandwidth of 0.20 GHz with −10 dB as the reference point.

On the other hand, the dielectric constant and the tangent loss of the liquid crystal molecules 81 to 84 are related to the bias voltage applied to the liquid crystal molecules 81 to 84.

As shown in FIG. 3B, observing the maximum scannable angle, when voltage is applied to liquid crystal units 81 and 82 and no voltage is applied to liquid crystal units 83 and 84, the beam scanning angle of the liquid crystal array antenna structure is −23 degrees and the gain is 9.17 dBi. In addition, when no voltage is applied to the liquid crystal units 81 and 82 and voltage is applied to the liquid crystal units 83 and 84, the beam scanning angle of the liquid crystal array antenna structure is 23 degrees and the gain is 9.05 dBi.

Accordingly, the beam scanning range of the liquid crystal array antenna structure is ±23 degrees.

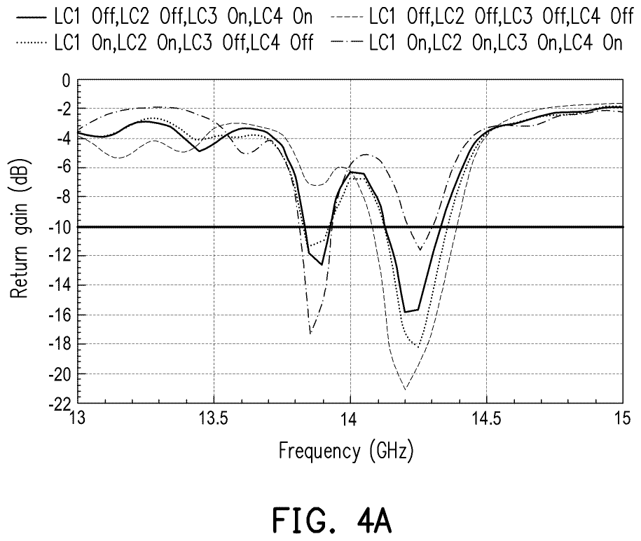

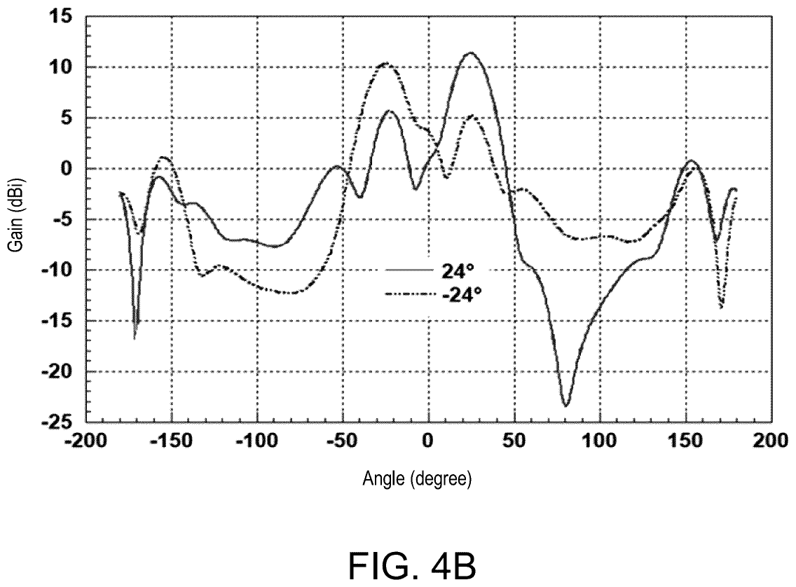

FIG. 4A is a schematic diagram showing the S11 parameter of the liquid crystal array antenna structure of the second embodiment of the disclosure. FIG. 4B shows a beam scanning gain diagram of the liquid crystal array antenna structure of the second embodiment of the disclosure. Referring to FIG. 4A and FIG. 4B, in this embodiment, the liquid crystal material used in the liquid crystal units 81 to 84 is MERCK GT7-29001.

As shown in FIG. 4A, when no voltage is applied to the liquid crystal units 81 to 84, the central operating frequency of the liquid crystal array antenna structure is between 14 GHz and 15 GHz (optimally 14.20 GHz), with a bandwidth of 0.27 GHz with −10 dB as the reference point.

As shown in FIG. 4A, when voltage is applied to the liquid crystal units 81 and 82 and no voltage is applied to the liquid crystal units 83 and 84, the central operating frequency of the liquid crystal array antenna structure is between 14 GHz and 15 GHz (optimally 14.25 GHz), with a bandwidth of 0.20 GHz with −10 dB as the reference point.

As shown in FIG. 4A, when voltage is applied to the liquid crystal units 83 and 84 and no voltage is applied to the liquid crystal units 81 and 82, the central operating frequency of the liquid crystal array antenna structure is between 14 GHz and 15 GHz (optimally 14.23 GHz), with a bandwidth of 0.20 GHz with −10 dB as the reference point.

As shown in FIG. 4A, when voltage is applied to the liquid crystal units 81 to 84, the central operating frequency of the liquid crystal array antenna structure is between 13 GHz and 14 GHz (optimally 13.95 GHz), with a bandwidth of 0.10 GHz with −10 dB as the reference point.

As shown in FIG. 4B, observing the maximum scannable angle, when voltage is applied to liquid crystal units 81 and 82 and no voltage is applied to liquid crystal units 83 and 84, the beam scanning angle of the liquid crystal array antenna structure is −24 degrees and the gain is 10.14 dBi. In addition, when no voltage is applied to the liquid crystal units 81 and 82 and voltage is applied to the liquid crystal units 83 and 84, the beam scanning angle of the liquid crystal array antenna structure is 24 degrees and the gain is 11.05 dBi.

Accordingly, the beam scanning range of the liquid crystal array antenna structure is ±24 degrees.

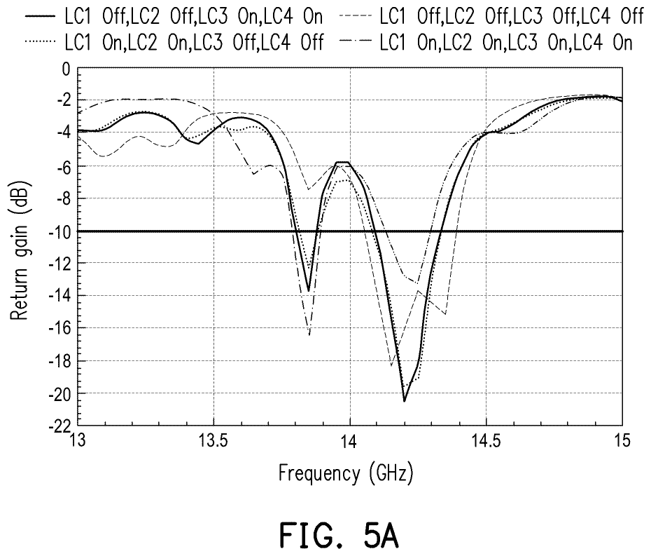

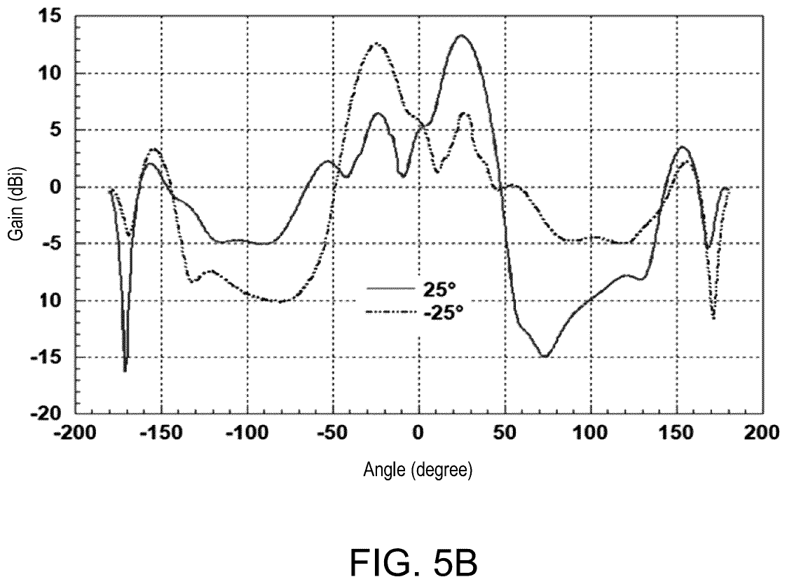

FIG. 5A is a schematic diagram showing the S11 parameter of the liquid crystal array antenna structure of the third embodiment of the disclosure. FIG. 5B shows a beam scanning gain diagram of the liquid crystal array antenna structure of the third embodiment of the disclosure. Referring to FIG. 5A and FIG. 5B, in this embodiment, the liquid crystal material used in the liquid crystal units 81 to 84 is JNC ZOC-A018XX.

As shown in FIG. 5A, when no voltage is applied to the liquid crystal units 81 to 84, the central operating frequency of the liquid crystal array antenna structure is between 14 GHz and 15 GHz (optimally 14.12 GHz), with a bandwidth of 0.32 GHz with −10 dB as the reference point.

As shown in FIG. 5A, when voltage is applied to the liquid crystal units 81 and 82 and no voltage is applied to the liquid crystal units 83 and 84, the central operating frequency of the liquid crystal array antenna structure is between 14 GHz and 15 GHz (optimally 14.20 GHz), with a bandwidth of 0.20 GHz with −10 dB as the reference point.

As shown in FIG. 5A, when voltage is applied to the liquid crystal units 83 and 84 and no voltage is applied to the liquid crystal units 81 and 82, the central operating frequency of the liquid crystal array antenna structure is between 14 GHz and 15 GHz (optimally 14.20 GHz), with a bandwidth of 0.20 GHz with −10 dB as the reference point.

As shown in FIG. 5A, when voltage is applied to the liquid crystal units 81 to 84, the central operating frequency of the liquid crystal array antenna structure is between 13 GHz and 14 GHz (optimally 13.95 GHz), with a bandwidth of 0.20 GHz with −10 dB as the reference point.

As shown in FIG. 5B, observing the maximum scannable angle, when voltage is applied to liquid crystal units 81 and 82 and no voltage is applied to liquid crystal units 83 and 84, the beam scanning angle of the liquid crystal array antenna structure is −25 degrees and the gain is 12.15 dBi. In addition, when no voltage is applied to the liquid crystal units 81 and 82 and voltage is applied to the liquid crystal units 83 and 84, the beam scanning angle of the liquid crystal array antenna structure is 25 degrees and the gain is 12.76 dBi.

Accordingly, the beam scanning range of the liquid crystal array antenna structure is ±25 degrees.

Based on the above-mentioned FIG. 3A to FIG. 5B, it may be seen that when a bias voltage is applied to the four liquid crystal units 81 to 84, the central operating frequency and the beam scanning range of the liquid crystal array antenna structure of the disclosure are respectively between 14 GHz to 15 GHz (Ku band) (also referred to as the first frequency band) and ±23 to ±25 degrees (also referred to as the first range). On the other hand, from the above-mentioned FIG. 3B, FIG. 4B and FIG. 5B, it may be seen that the side lobes have been effectively suppressed.

To sum up, the liquid crystal array antenna structure provided in the embodiment of the disclosure, through its special structural design, may achieve the central operating frequency and beam scanning range that may meet the communication requirements of low Earth orbit satellites, and may effectively suppress the side lobe level to achieve good transmission performance.

What is claimed is:

1. A liquid crystal array antenna structure, comprising:
a first substrate layer, having a first upper surface and a first lower surface;
a second substrate layer, having a second upper surface and a second lower surface;
a third substrate layer, having a third upper surface and a third lower surface;
four liquid crystal units, arranged between the first substrate layer and the second substrate layer; and
a first surface unit, arranged at the first lower surface;
a second surface unit, arranged at the second upper surface;
a third surface unit, arranged at the third upper surface;
a fourth surface unit, arranged at the third lower surface;
wherein a central operating frequency and a beam scanning range of the liquid crystal array antenna structure are a first frequency band and a first range respectively when a bias voltage is applied to the liquid crystal units.

2. The liquid crystal array antenna structure according to claim 1,
wherein the first surface unit comprises four first surface internally wound bias metal wires,
wherein the four first surface internally wound bias metal wires respectively correspond to the four liquid crystal units.

3. The liquid crystal array antenna structure according to claim 2,
wherein the second surface unit comprises four second surface region patch group,
wherein the four second surface region patch groups respectively correspond to the four liquid crystal units.

4. The liquid crystal array antenna structure according to claim 3, wherein the third surface unit is a metal ground layer.

5. The liquid crystal array antenna structure according to claim 4, wherein the fourth surface unit comprises two three-stage one-to-six distribution lines.

6. The liquid crystal array antenna structure according to claim 2, wherein each of the first surface internally wound bias metal wires is an equidistant square spiral metal wire.

7. The liquid crystal array antenna structure according to claim 6, wherein a number of turns of the equidistant square spiral metal wire is at least 2.

8. The liquid crystal array antenna structure according to claim 2, wherein each of the first surface internally wound bias metal wires is connected to an edge of the first lower surface.

9. The liquid crystal array antenna structure according to claim 3, wherein the four second surface region patch groups are arranged in a binomial array.

10. The liquid crystal array antenna structure according to claim 3, wherein each of the second surface region patch groups comprises three surface cross-shaped patches, and central points of the three surface cross-shaped patches are connected to each other through surface inner metal wires.

11. The liquid crystal array antenna structure according to claim 10, wherein one of the three surface cross-shaped patches is connected to an edge of the second upper surface through a surface outer metal wire.

12. The liquid crystal array antenna structure according to claim 10,
wherein each of the surface cross-shaped patches comprises a surface left-side patch, a surface central patch, a surface right-side patch and a surface connection patch,
wherein the surface left-side patch, the surface central patch, and the surface right-side patch are connected through the surface connection patch,
wherein a length and a width of the surface left-side patch are the same as a length and a width of the surface right-side patch,
wherein a length of the surface central patch is greater than the length of the surface left-side patch and the length of the surface right-side patch,
wherein the width of the surface left-side patch, a width of the surface central patch, and the width of the surface right-side patch are the same.

13. The liquid crystal array antenna structure according to claim 4,
wherein the third surface unit comprises four surface slit groups,
wherein the four surface slit groups respectively correspond to the four liquid crystal units.

14. The liquid crystal array antenna structure according to claim 13, wherein each of the surface slit groups comprises three third surface slits.

15. The liquid crystal array antenna structure according to claim 14, wherein the third surface slits are H-shaped slits.

16. The liquid crystal array antenna structure according to claim 5, wherein feeding terminals of the two three-stage one-to-six distribution lines are connected to edges of the third lower surface.

17. The liquid crystal array antenna structure according to claim 5, wherein output terminals of the two three-stage one-to-six distribution lines respectively correspond to the third surface slits of the third surface unit.

18. The liquid crystal array antenna structure according to claim 1,
wherein the second surface unit comprises four second surface region patch groups,
wherein the four second surface region patch groups respectively correspond to the four liquid crystal units.

19. The liquid crystal array antenna structure according to claim 1, wherein the third surface unit is a metal ground layer.

20. The liquid crystal array antenna structure according to claim 1, wherein the fourth surface unit comprises two three-stage one-to-six distribution lines.
